(19) United States
(12) Patent Application Publication
(10) Pub. No.: US 2017/0350433 A1
(43) Pub. Date: Dec. 7, 2017

(54) FASTENING DEVICE FOR PREVENTING SEPARATION OF INJECTION MOLDING PARTS

(71) Applicant: NIFCO KOREA INC., Asan-si, Chungcheongnam-do (KR)

(72) Inventor: Yoon Hwan SHIN, Asan-si (KR)

(73) Assignee: NIFCO KOREA INC., Asan-si, Chungcheongnam-do (KR)

(21) Appl. No.: 15/534,674

(22) PCT Filed: Dec. 11, 2015
(86) PCT No.: PCT/KR2015/013597

§ 371 Date: Jun. 9, 2017

(30) Foreign Application Priority Data
Dec. 12, 2014 (KR) 10-2014-0179571

(51) Int. Cl. F16B 5/06

(52) U.S. Cl. CPC F16B 5/0664; F16B 5/0635

(57) ABSTRACT

The present invention relates to a fastening device for preventing the separation of injection molding parts, in which two parts formed of plastics by injection molding can be coupled to or decoupled from each other without using any additional coupling members through the improvement of the coupling structure thereof. To this end, in a fastening device for preventing the separation of injection molding parts, in which a first part (11) is formed with an elastic piece (12) having a coupling hole (13) to hold a hook (17) formed on a second part (14), the second part (14) has a coupling member (16) integrally formed at one side of the second part (14) and having a space part (15), equal to or larger than the thickness of the elastic piece (12) twice or more, and the hook (17) formed on the inside of the coupling member (16) so as to be held in the coupling hole (13) of the elastic piece (12), and the elastic piece (12) formed with the coupling hole (13) has a handle part (12a) to be exposed to the upper portion of the coupling member (16) so as to be positioned in the space part (15) of the coupling member (16) when the first part (11) and the second part (14) are coupled to each other.

### TECHNICAL FIELD

The present invention relates to a fastening device for preventing the separation of injection molding parts, in which two parts formed of plastics by injection molding are coupled without using any additional coupling members, and the two parts thus coupled to each other can be readily separated from each other through the improvement of the coupling structure between the two parts instead of using any additional tools.

### BACKGROUND ART

In general, when assembling two parts, formed of plastics by injection molding, with each other using a coupling member such as a screw is likely to decrease the assembly thereof with a concern about the generation of a defective product due to the coupling failure of the screw. In addition, in order to separate the two parts for the purpose of repair and the like, an additional tool for releasing the screw is required, thereby making the work inconvenient.

Therefore, an elastic piece having a coupling hole has been recently provided to at least one of the parts in order to avoid the use of any additional coupling member and a hook is provided to the other corresponding part so as to be held and supported in the coupling hole of the elastic piece such that the two parts can be coupled to each other.

FIG. 1 is an exploded perspective view showing a prior art coupling device, FIGS. 2a to 2c are cross-sectional views showing the coupling states of a first part and a second part, and FIG. 3 is a cross-sectional view showing the procedure for separating the first part and the second part, which are coupled to each other, from each other. Referring to FIG. 1 to FIG. 3, a first part 1 has an elastic piece 2, which is formed at one end and has a coupling hole 3, and a second part 4 has a hook 6, which is formed on an indented surface 5 at a position corresponding to the coupling hole 3 of the elastic piece 2, such that the first part 1 and the second part 4 are coupled to each other. Herein, the length of the elastic piece 2 is set such that a gap 7 is formed when the hook 6 formed on the indented surface 5 is coupled to the coupling hole 3 formed in the elastic piece 2 so as to be held therein.

Therefore, if the first part 1 is pushed in the direction of an arrow, as shown in FIG. 2a, in a state, in which the elastic piece 2 formed on the first part 1 is in contact with the indented surface 5 formed on the second part 4 in order to couple the first part 1 and the second part 4 to each other, the elastic piece 2 can be deformed outwards by the inclined surface 6a of the hook 6 as shown in FIG. 2b (right side on FIG. 2b). Then, the hook 6 is fitted into the coupling hole 3 formed in the elastic piece 2, as shown in FIG. 2c, while the deformed elastic piece 2 is restored to the initial position thereof at a point where the hook 6 is in accordance with the coupling hole 3 formed in the elastic piece 2. Therefore, the coupling work of the first part 1 and the second part 4 is finished.

If the first part 1 and the second part 4 are separated from each other for the purpose of repair and the like in the state, where the first part 1 and the second part 4 are coupled as above, an additional tool 8 is pushed into the gap 7, which is formed between the elastic piece 2 and the indented surface 5, and then the tool is moved back, as shown in FIG. 3, such that the elastic piece 2 can be deformed in the right direction of FIG. 3 and thus the hook 6 fitted into the coupling hole 3 of the elastic piece 2 escapes out of the coupling hole 3. Therefore, the separation of the first part 1 and the second part 4 is realized.

[Prior Art Document]

[Patent Document 1] Japanese Utility Model Reg. Publication No. 05-290956 (26 Nov. 2009)

### DISCLOSURE OF INVENTION

### Technical Problem

The prior art device in the above mentioned structure has the advantage of coupling two parts without using any additional coupling member, thereby improving the convenience of coupling work. However, the prior art device has various problems as follows.

First, in order to separate thus coupled two parts for the purpose of repair and the like, it is necessary to separate the hook from the coupling hole of the elastic piece by pushing back the elastic piece by means of an additional tool such that the hook can escape from the coupling hole. Therefore, the separation work of the two parts is troublesome.

Second, the elastic piece is likely to be deformed in the process of pushing back the elastic piece by means of a tool since the elastic piece is formed of a synthetic resin material. Therefore, there is a problem that thus separated two parts cannot be firmly coupled but diverge from each other in the process of re-assembling the two parts after the repair and the like.

Third, there is a critical defect that, if the elastic piece is excessively pushed back by means of a tool, the elastic piece may break and thus the parts cannot be coupled.

Fourth, the hook for coupling the parts to each other is exposed to the outside such that the hook is likely to be damaged by unintentional external force.

Accordingly, the present invention has been derived to solve the above-mentioned problems and disadvantages occurring in the prior arts, and it is an objective of the present invention to provide a fastening device for preventing the separation of injection molding parts, wherein the structure of forming a hook, which is to be held in a coupling hole formed in an elastic piece such that two parts can be stably coupled to each other, is improved such that the two parts can be separated with speed without using any additional tools.

It is another objective of the present invention to provide a fastening device for preventing the separation of injection molding parts, wherein an elastic piece is prevented from being deformed or breaking when coupled two parts are separated from each other.

It is a further objective of the present invention to provide a fastening device for preventing the separation of injection molding parts, wherein a hook for maintaining the coupled state of two parts is prevented from being exposed to the outside such that the deformation of or damage to the hook by unintended external force can be prevented in advance.

### Solution to Problem

To accomplish the above objectives, according to one aspect of the present invention, there is provided a fastening device for preventing the separation of injection molding parts, in which a first part is formed with an elastic piece having a coupling hole such that a hook formed on a second part is held in the coupling hole so as to be held therein, characterized in that the second part has a coupling member, which is integrally formed at one side of the second part and has a space part equal to or larger than the thickness of the elastic piece twice or more, the coupling member has the hook formed on the inside of the coupling member so as to be held in the coupling hole of the elastic piece, and the elastic piece formed with the coupling hole has a handle part formed to be exposed to the upper portion of the coupling member when the first part and the second part are coupled to each other such that the elastic piece is coupled so as to be positioned in the space part of the coupling member.

### Advantageous Effects of Invention

A fastening device for preventing the separation of injection molding parts, according to the present invention, as described above has various advantages as follows in comparison with the prior art device.

First, in order to separate coupled two parts from each other for the purpose of repair and the like, the handle part which is exposed to the upper portion of the coupling member is pushed towards the space part such that the hook is separated from the coupling hole. Therefore, the separation of the two parts can be readily carried out without using any additional tools.

Second, the phenomenon of the deformation or breakage of the elastic piece, which is formed of a synthetic resin material, can be prevented in advance since no tool is used. Therefore, even though the first part and the second part are re-coupled to each other after repair and the like, a tightly coupled state can be maintained.

Third, the hook, which is to couple the first part and the second part to each other, is positioned in the coupling member but not exposed to the outside such that the phenomenon that the hook is damaged by external force can be prevented in advance.

Fourth, reinforcement pieces are formed at an upper portion and a lower portion on the outside of the coupling member so as to prevent the deformation of the coupling member such that the space part formed in the coupling member can be stably secured.

### BRIEF DESCRIPTION OF DRAWINGS

The above and other objectives, features and advantages of the present invention will be apparent from the following detailed description of the preferred embodiments of the invention in conjunction with the accompanying drawings, in which:

FIG. 1 is an exploded perspective view showing a prior art coupling device.

FIG. 2a to FIG. 2c are cross-sectional views showing the coupled states of a first part and a second part.

FIG. 3 is a cross-sectional view showing the procedure of separating the coupled first and second parts, which have been coupled to each other, from each other.

FIG. 4 is an exploded perspective view showing a coupling device according to the present invention.

FIG. 5a to FIG. 5c are cross-sectional views showing the coupled states of a first part and a second part, and

FIG. 6 is a cross-sectional view showing the procedure of separating the first part and the second part, which have been coupled to each other, from each other.

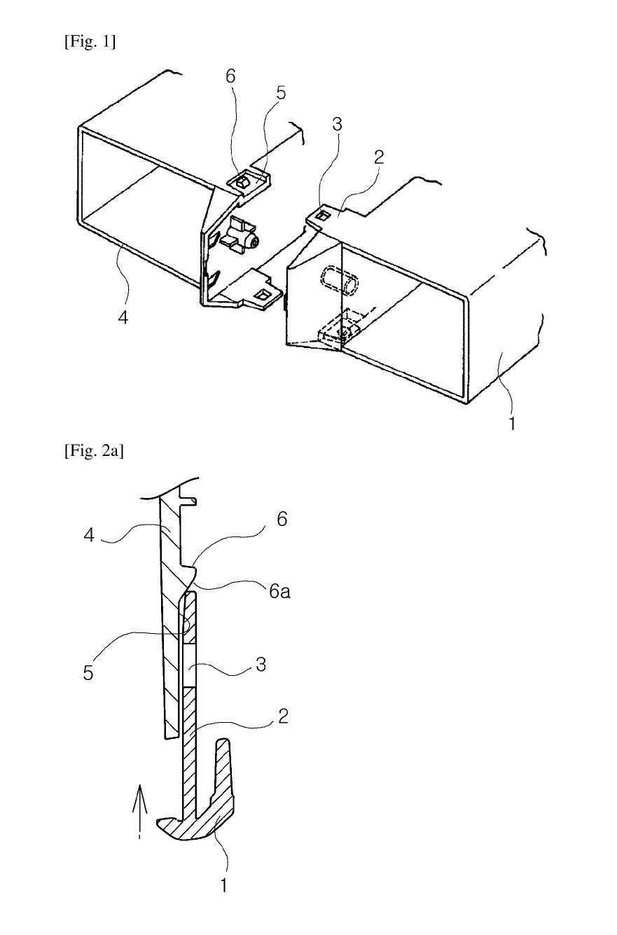

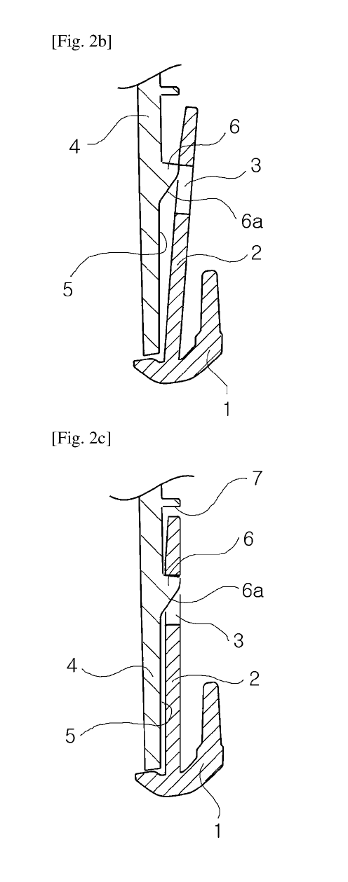

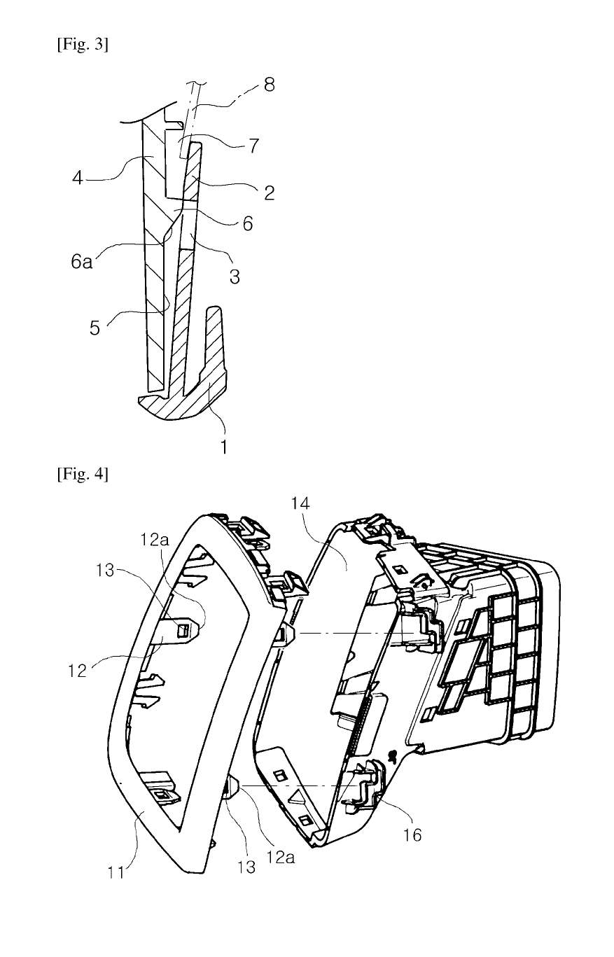

### BRIEF EXPLANATION OF REFERENCE SIGNS

11: first part 12: elastic piece

12a: handle part 13: coupling hole

14: second part 15: space part

16: coupling member

17: hook 18: reinforcement pieces

### Best Mode for Carrying out the Invention

Hereinafter, reference will be now made to the preferred embodiments of the present invention with reference to the attached drawings in a manner sufficiently detail to be readily carried out by a person skilled in the art, to which the present invention belongs. The present invention can be implemented in various different ways and is not limited to the explained embodiments. It should be noted that the drawings are schematically illustrated but not scaled in proportion. Therefore, in the attached drawings, the relative dimensions and proportions of the components are illustrated to be more enlarged or reduced than they actually are in order to clarify the present invention, and a certain size is just illustrative but not limited thereto. In the drawings, the same structures, elements or parts have the same reference numerals so as to denote similar features even though they are illustrated in different figures.

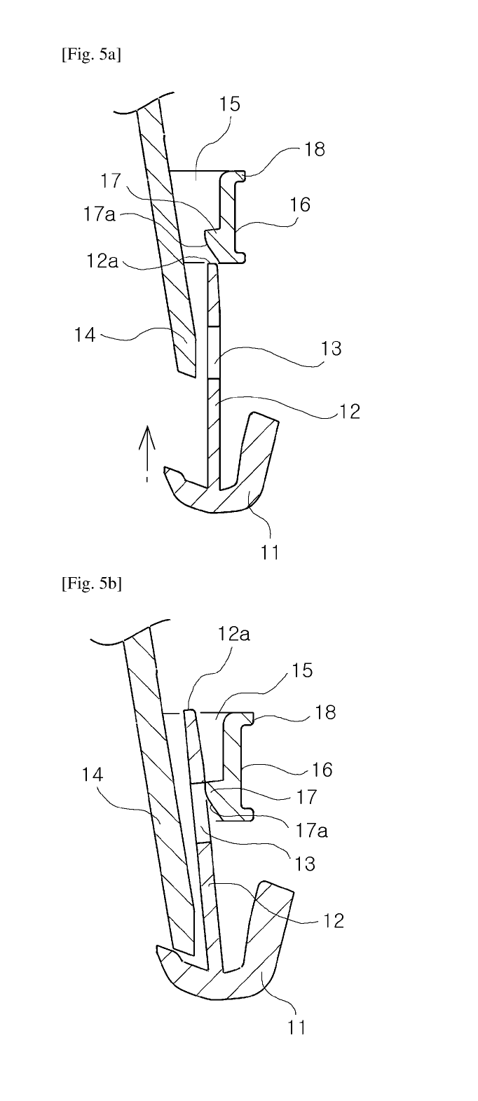

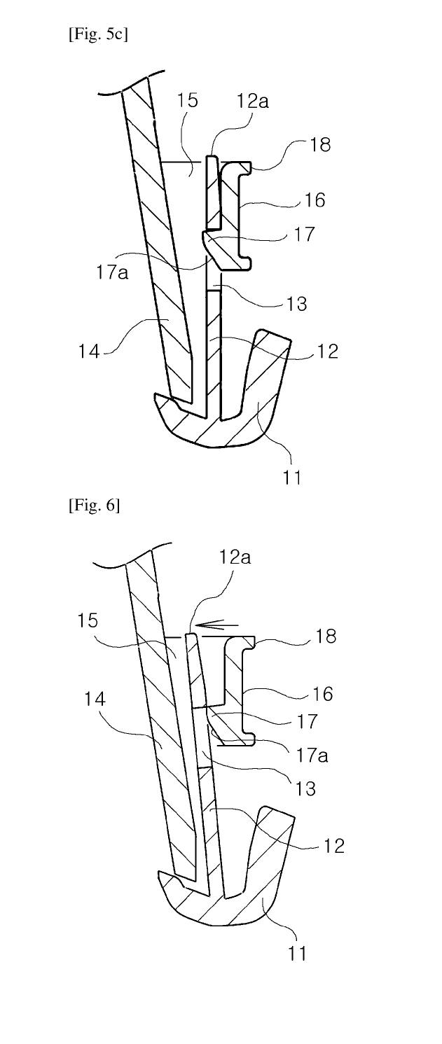

FIG. 4 is an exploded perspective view showing a coupling device according to the present invention, FIG. 5a to FIG. 5c are cross-sectional views showing the coupled states of a first part and a second part, and FIG. 6 is a cross-sectional view showing the procedure of separating the first part and the second part, which have been coupled to each other, from each other. According to the present invention, a second part 14 has a coupling member 16, which is integrally formed at one side of the second part 14 and has a space part 15 equal to or larger than the thickness of an elastic piece 12 twice or more, the coupling member 16 has a hook 17 formed on the inside of the coupling member 16 so as to be held in a coupling hole 13 of the elastic piece 12, and the elastic piece 12 provided to a first part 11 so as to be coupled to the coupling member 16 has a handle part 12a formed to be exposed to the upper portion of the coupling member 16 when the first part 11 and the second part 14 are coupled to each other.

The coupling member 16 has reinforcement pieces 18, which are integrally formed at an upper portion and a lower portion on the outside thereof, and the reinforcement pieces 18 increase the strength of the coupling member 16 such that the coupling member 16 is not deformed even though external force is applied thereto, thereby stably securing the space part 15.

Hereinafter, the operations of the present invention structured as above will now be described in detail.

First, in order to couple the first part 11 and the second part 14 to each other, if the first part 11 is pushed in the direction of an arrow, as shown in FIG. 5a, in a state, in which the elastic piece 12, which is formed on the first part 11, is in close contact with the inclined surface 15a of the hook 15, which is formed on the inner surface of the coupling member 16, such that the elastic piece 12 formed on the first part 11 is positioned in the space part 15 of the coupling member 16 formed on the second part 14, then the elastic piece 12 is deformed outwards (left side in FIG. 5b) by an inclined surface 17a of the hook 17, as shown in FIG. 5b. After that, the hook 17 is fitted into the coupling hole 13 formed in the elastic piece 12, as shown in FIG. 5c, while the deformed elastic piece 12 is restored to the initial position thereof at a point where the hook 17 is in accordance with the coupling hole 13 formed in the elastic piece 12. Therefore, the elastic piece 12 comes into close contact with the inner surface of the coupling member 16 and the coupling work of the first part 11 and the second part 4 is finished.

In the case where the first part 11 and the second part 14 are to be separated for the purpose of repair and the like in a state, in which the first part 11 and the second part 14 are coupled to each other as described above, if the handle part 12a of the elastic member 12, exposed to the upper portion of the coupling member 16, is pushed in the direction of an arrow, as shown in FIG. 6, then the hook 17 which is fitted into the coupling hole 13 of the elastic piece 12 escapes from the coupling hole 13 while the elastic piece 12 is deformed in the left direction on FIG. 6, thereby enabling the separation of the first part 11 and the second part 14.

As described above, while the present invention has been particularly shown and described with reference to the example embodiments thereof, it will be understood by a person skilled in the art, to which the present invention belongs, that the above embodiments of the present invention are all exemplified and various changes, modifications and equivalents may be made therein without changing the essential characteristics and scope of the present invention. Therefore, it would be understood that the present invention is not limited to the forms described in the example embodiments and the technical and protective scope of the present invention shall be defined by the following claims. In addition, it should be also understood that all modifications, changes and equivalences within the technical scope of the present invention defined by the following claims belong to the technical scope of the present invention.

1. A fastening device for preventing the separation of injection molding parts, in which a first part (11) is formed with an elastic piece (12) having a coupling hole (13) such that a hook (17) formed on a second part (14) is held in the coupling hole (13) so as to be held therein, characterized in that:
the second part (14) has a coupling member (16), which is integrally formed at one side of the second part (14) and has a space part (15) equal to or larger than the thickness of the elastic piece (12) twice or more, the coupling member (16) has the hook (17) formed on the inside of the coupling member (16) so as to be held in the coupling hole (13) of the elastic piece (12), and the elastic piece (12) formed with the coupling hole (13) has a handle part (12a) formed to be exposed to the upper portion of the coupling member (16) when the first part (11) and the second part (14) are coupled to each other such that the elastic piece (12) is coupled so as to be positioned in the space part (15) of the coupling member (16).

2. The fastening device for preventing the separation of injection molding parts according to claim 1, wherein reinforcement pieces (18) are integrally formed at an upper portion and a lower portion on the outside of the coupling member (16).
